(19) United States
(12) Patent Application Publication
(10) Pub. No.: US 2009/0303550 A1
(43) Pub. Date: Dec. 10, 2009

(54) IMAGE PROCESSING APPARATUS AND IMAGE PROCESSING METHOD

(75) Inventor: Kazunori Hirabayashi, Suntou-gun (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/476,634

(22) Filed: Jun. 2, 2009

Related U.S. Application Data
(60) Provisional application No. 61/059,114, filed on Jun. 5, 2008.
(60) Provisional application No. 61/059,117, filed on Jun. 5, 2008.

(51) Int. Cl. H04N 1/40

(52) U.S. Cl. 358/448

(57) ABSTRACT

To generate an image used for image formation by processing with less image deterioration when a page image including plural kinds of objects is formed. An image processing apparatus extracts identification information for identifying types of objects included in a bitmap image and identifying to which objects respective pixels of the bitmap image correspond, generates a first image including a first image area in the page and a second image including a second image area different from the first image area such that at least one of the images is an image given with an extension area crossing a boundary between an image area corresponding to the image and the other image area, compresses the first image according to an irreversible compression system and compresses the second image according to a reversible compression system, causes a storage area to store compressed information, acquires the compressed information stored in the predetermined storage area, expands the acquired information, and adopts image information of the second image to combine the expanded first image and second image in overlapping sections caused by an extension area of at least one of the first image and the second image.

### CROSS-REFERENCE TO RELATED APPLICATION

This application is based upon and claims the benefit of priority from: U.S. provisional application 61/059,114, filed on Jun. 5, 2008; and U.S. provisional application 61/059,117, filed on Jun. 5, 2008, the entire contents of each of which are incorporated herein by reference.

### TECHNICAL FIELD

The present invention relates to an efficient compression technique for data, and, more particularly to a compression technique for an image generated on the basis of plural kinds of data in an image processing apparatus such as a multi function peripheral (MFP).

### BACKGROUND

Conventionally, when a user performs printing using a multi function peripheral (MFP), a printer, or the like (hereinafter referred to as “MFP or the like”), first, the MFP or the like receives a PDL (Page Description Language) file of data, which is printed in a print job, from a client personal computer or the like. A RIP (Raster Image Processor) included in the MFP or the like analyzes the acquired PDL file to generate bitmapped print images for respective pages on a memory and, then, compresses the images to temporarily store the images in a HDD. In finally printing the images, the RIP expands the compressed images to perform image formation (printing).

In order to more efficiently perform the compression processing, for example, when image, text, and graphics objects are included in a page of a PDL file to be processed, the RIP divides a bitmap image generated by the RIP into an image and text and graphics and applies divide kinds of compression processing to images of the image, text, and graphics objects. Concerning the image of the image object having a large volume, irreversible compression processing such as JPEG is performed in which some deterioration such as a blur of an edge of the image occurs but data compression at a high compression ratio is possible. On the other hand, concerning the image of the text and graphics in which deterioration such as a blur of an edge of the object tends to occur when the image is compressed by irreversible compression, reversible compression processing without image deterioration is performed.

With the compression processing explained above, the image including the text and graphics objects can be compressed to prevent edges thereof from blurring. However, in the image including only the image object, if a background color of the image is white, areas of the text and the graphics cut by the division processing appear in a state of white void. Then, when there is an edge in the cut areas of the text and the graphics, eventually, the edge appears in an image area of the image in a state of white void. This causes a blur when image data is compressed.

### SUMMARY

It is an object of an embodiment of the present invention to provide a technique for generating an image used for image formation according to processing with less image deterioration when a page image including plural kinds of objects is formed in an image processing apparatus such as a MFP.

In order to solve the problems, an image processing apparatus according to an aspect of the present invention includes: an information acquiring unit that acquires page information concerning a page, for which image formation is performed, described in page description language; an image extracting unit that extracts a bitmap image on the basis of the page information acquired by the information acquiring unit; an identification-information extracting unit that extracts, on the basis of the page information, identification information for identifying types of objects included in the page information and identifying to which objects respective pixels of the bitmap image correspond; a divided-image generating unit that generates, on the basis of the identification information, a first image including a first image area in the page and a second image including a second image area different from the first image area, the divided-image generating unit generating at least one of the images as an image given with an extension area crossing a boundary between an image area corresponding to the image and the other image area; a compressing unit that compresses the first image according to an irreversible compression system and compresses the second image according to a reversible compression system; a storage control unit that causes a predetermined storage area to store information compressed by the compressing unit; a compressed-information acquiring unit that acquires the compressed information stored in the predetermined storage area; an expanding unit that expands the information acquired by the compressed-information acquiring unit; and a combining unit that combines the first image and the second image expanded by the expanding unit, the combining unit adopting image information of the second image to combine the first image and the second image in overlapping sections caused by an extension area of at least one of the first image and the second image.

An image processing method according to another aspect of the present invention includes: acquiring page information concerning a page, for which image formation is performed, described in page description language; extracting a bitmap image on the basis of the acquired page information; extracting, on the basis of the page information, identification information for identifying types of objects included in the page information and identifying to which objects respective pixels of the bitmap image correspond; generating, on the basis of the identification information, a first image including a first image area in the page and a second image including a second image area different from the first image area such that at least one of the images is an image give with an extension area crossing a boundary between an image area corresponding to the image and the other image area; compressing the first image according to an irreversible compression system and compressing the second image according to a reversible compression system; causing a predetermined storage area to store the compressed information; acquiring the compressed information stored in the predetermined storage area; expanding the acquired information; and combining the expanded first image and the expanded second image by adopting image information of the second image in overlapping sections caused by an extension area of at least one of the first image and the second image.

An image processing program according to still another aspect of the present invention causes a computer to execute processing for: acquiring page information concerning a page, for which image formation is performed, described in page description language; extracting a bitmap image on the basis of the acquired page information; extracting, on the basis of the page information, identification information for identifying types of objects included in the page information and identifying to which objects respective pixels of the bitmap image correspond; generating, on the basis of the identification information, a first image including a first image area in the page and a second image including a second image area different from the first image area such that at least one of the images is an image given with an extension area crossing a boundary between an image area corresponding to the image and the other image area; compressing the first image according to an irreversible compression system and compressing the second image according to a reversible compression system; causing a predetermined storage area to store the compressed information; acquiring the compressed information stored in the predetermined storage area; expanding the acquired information; and combining the expanded first image and the expanded second image by adopting image information of the second image in overlapping sections caused by an extension area of at least one of the first image and the second image.

### DESCRIPTION OF THE DRAWINGS

FIG. 1 is a system diagram for explaining a configuration of an image processing apparatus according to a first embodiment of the present invention and a system including the image processing apparatus and a terminal;

FIG. 2 is a functional block diagram for explaining the image processing apparatus according to the first embodiment;

FIG. 3 is a detailed functional block diagram concerning a RIP unit among functional blocks shown in FIG. 2;

FIG. 4 is a diagram for explaining, by showing examples of images, a flow of image processing performed by the image processing apparatus according to the first embodiment;

FIG. 5 is a diagram for explaining extended identification information generation processing performed by the image processing apparatus according to the first embodiment;

FIG. 6 is a functional block diagram for explaining information expansion processing and information combination processing performed by the image processing apparatus according to the first embodiment;

FIG. 7 is a flowchart for explaining processing for finally compressing information such as images and temporarily storing the information in a HDD in a flow of processing executed by the image processing apparatus according to the first embodiment;

FIG. 8 is a flowchart for explaining processing for finally expanding the compressed information and combining the images in the flow of the processing executed by the image processing apparatus according to the first embodiment;

FIG. 9 is a flowchart of processing for finally compressing information such as images and temporarily storing the information in a HDD in a flow of processing executed by an image processing apparatus according to a second embodiment of the present invention;

FIG. 10 is a diagram for explaining extended identification information generation processing according to a third embodiment of the present invention;

FIG. 11 is a diagram for explaining an image processing method according to a fourth embodiment of the present invention;

FIG. 12 is a functional block diagram for explaining an image processing apparatus according to a fifth embodiment of the present invention;

FIG. 13 is a detailed functional block diagram concerning a RIP unit according to the fifth embodiment;

FIG. 14 is a diagram for explaining, by showing examples of images, a flow of image processing performed by the image processing apparatus according to the fifth embodiment;

FIG. 15 is a diagram for explaining, by showing a part of a bitmap image on an image layer, processing for generating an extension area;

FIG. 16 is a diagram for explaining, by showing a part of a bitmap image on an image layer, processing for generating an extension area;

FIG. 17 is a diagram for explaining, by showing a part of a bitmap image on an image layer, processing for generating an extension area;

FIG. 18 is a flowchart for explaining processing for finally compressing information such as images and temporarily storing the information in a HDD in a flow of processing executed by the image processing apparatus according to the fifth embodiment;

FIG. 19 is a diagram for explaining, by schematically showing a part of a bitmap image on an image layer, processing for generating an extension area according to a sixth embodiment of the present invention; and

FIG. 20 is a diagram for explaining, by schematically showing a part of a bitmap image of an image layer, processing for generating an extension area according to the sixth embodiment.

### DETAILED DESCRIPTION

Embodiments of the present invention are explained below with reference to the accompanying drawings.

### First Embodiment

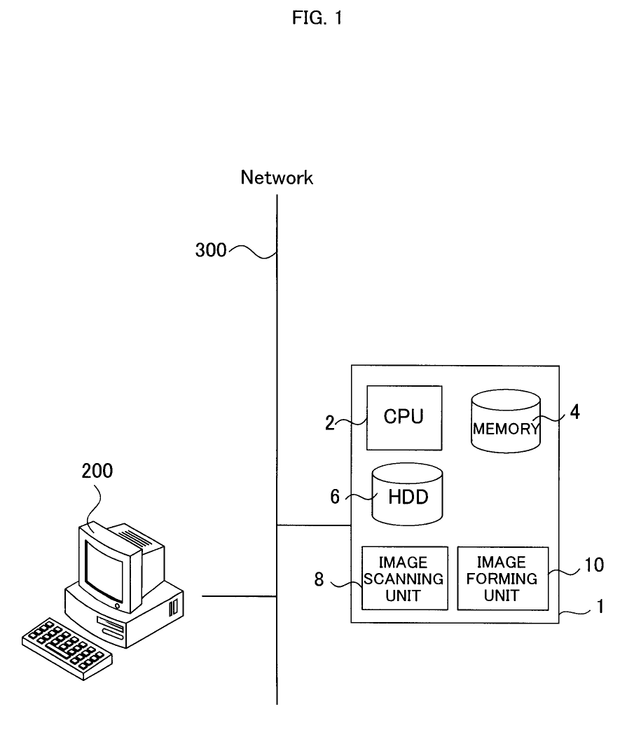

FIG. 1 is a system diagram for explaining a configuration of an image processing apparatus according to a first embodiment of the present invention and a system including the image processing apparatus and a terminal.

An image processing apparatus 1 shown in FIG. 1 is a multi function peripheral (MFP) having plural functions such as printer, scanner, and facsimile functions. The image processing apparatus 1 is connected to a terminal 200 such as a personal computer and not-shown other terminals via a network 300. The network 300 can be realized by a LAN, a WAN, the Internet, or the like. Connection between the image processing apparatus 1 and the network 300 may be wire connection or wireless connection.

When the image processing apparatus 1 receives a print job file written in a page description language (PDL) (hereinafter referred to as “PDL file”) from a client such as the terminal 200, the image processing apparatus 1 can apply image formation to a sheet such as paper or an OHP sheet on the basis of the acquired PDL file.

The “PDL” file is a text file generated in the page description language (PDL) for each of pages to be printed. The image processing apparatus 1 generates, on the basis of the PDL file, an image to be formed. Examples of the PDL include PostScript (registered trademark of Adobe Systems Incorporated), PDF, PCL, and XPS. In the explanation of this specification, it is assumed that the PDL is PostScript.

In the PDL file, objects are defined by various rendering operators according to types of objects included in an original file. Usually, a file treated in printing is information including any one of three kinds of objects, i.e., image attribute object, text attribute object, and graphics attribute object, or a mixture of the objects. Therefore, when the PDL is PostScript, in the PDL file, the image object is defined by an “image” operator, the text object is defined by a “Show” operator, and the graphics object is defined by a “stroke” operator or a “fill” operator. When the image processing apparatus 1 as a MFP receives the PDL file as a print job, a RIP (Raster Image Processor) analyzes the PDL file and converts, on the basis of a condition designated by the PDL file, a page to be printed into a bitmap image. The image processing apparatus 1 forms an image on the sheet on the basis of the bitmap image.

The image is image data picked up by a digital camera or image data obtained by scanning an original document with a scanner or the like. The text is data of a character string. The graphics is figure data created by graphic software or the like.

A configuration of the image processing apparatus 1 shown in FIG. 1 is explained.

As explained above, the image processing apparatus 1 is a multi function peripheral (MFP) and has plural functions such as a printer function, a copy function, a scan function, and a facsimile function.

The image processing apparatus 1 includes a CPU 2, a memory 4, a hard disk drive (HDD) 6, an image scanning unit 8, and an image forming unit 10.

The CPU 2 controls various kinds of processing in the image processing apparatus 1. In addition, in this embodiment, the CPU 2 executes processing for compressing, with a method excellent in a compression ratio and having less deterioration in data, a bitmap image created on the basis of a PDL file transmitted from the terminal 200 or the like to temporarily store the bitmap image, expanding compressed data, and outputting an image to perform image formation. The CPU 2 can also execute various programs stored in the memory 4.

The memory 4 stores a program used for image processing in the image processing apparatus 1. The memory 4 can be, for example, a RAM (Random Access Memory), a ROM (Read Only Memory), a DRAM (Dynamic Random Access Memory), an SRAM (Static Random Access Memory), a VRAM (Video RAM), and the like.

The HDD 6 is a storage device that temporarily stores a bitmap image created by the RIP of the image processing apparatus 1 on the basis of the PDL file. The HDD 6 is not limited to a hard disk drive and may be any storage device as long as the storage device can temporarily store information. The HDD 6 may be, for example, a RAM, a ROM, a DRAM, an SRAM, and a VRAM.

The image scanning unit 8 is an image scanning device for scanning an original document in performing scanning and copying using the image processing apparatus 1.

The image forming unit 10 is a device that forms an image on a sheet such as a copy sheet, thick paper, or an OHP film on the basis of image data obtained by scanning an original document with the image scanning unit 8, data acquired via the network 300, or data acquired from an external memory such as a memory card.

The terminal 200 is an information processing apparatus such as a personal computer. The terminal 200 includes, for example, a computer that performs information processing, a keyboard and a mouse for performing operation input, and a display that displays a screen. A user can transmit data to be formed as an image from the terminal 200 to the image processing apparatus 1 by operating the terminal 200 connected to the image processing apparatus 1 via the network 300. The image processing apparatus 1 can form an image on a sheet. When the user transmits information to be formed as an image from the terminal 200 to the image processing apparatus 1 to perform image formation, the terminal 200 converts an original file to be printed such as a document file and an image file into a PDL file and transmits the PDL file to the image processing apparatus 1 via the network 300. Finally, the image processing apparatus 1 that receives the PDL file can form an image on the sheet on the basis of the received PDL file. As explained above, an apparatus that transmits the PDL file as a print job to the image processing apparatus 1 is not limited to the terminal 200 and may be any terminal connected to the image processing apparatus 1 via a network.

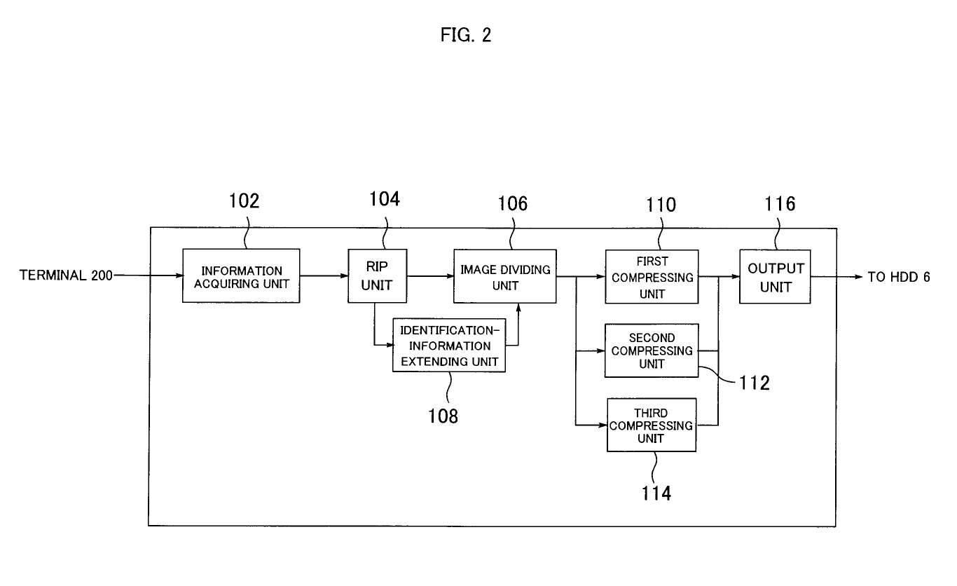

Details of image processing for performing image formation by the image processing apparatus 1 according to the first embodiment are explained below with reference to FIGS. 2 to 6.

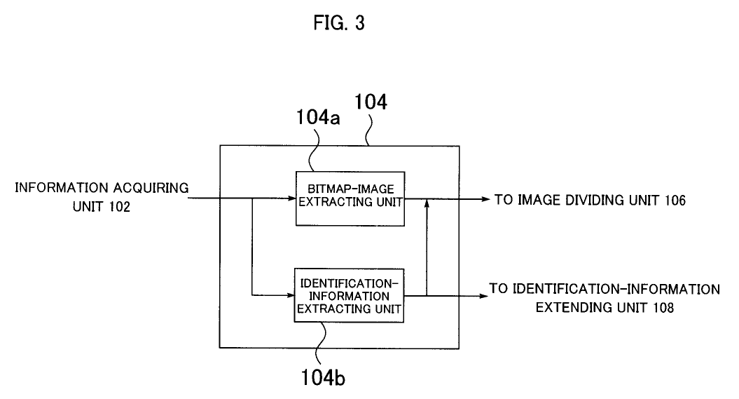

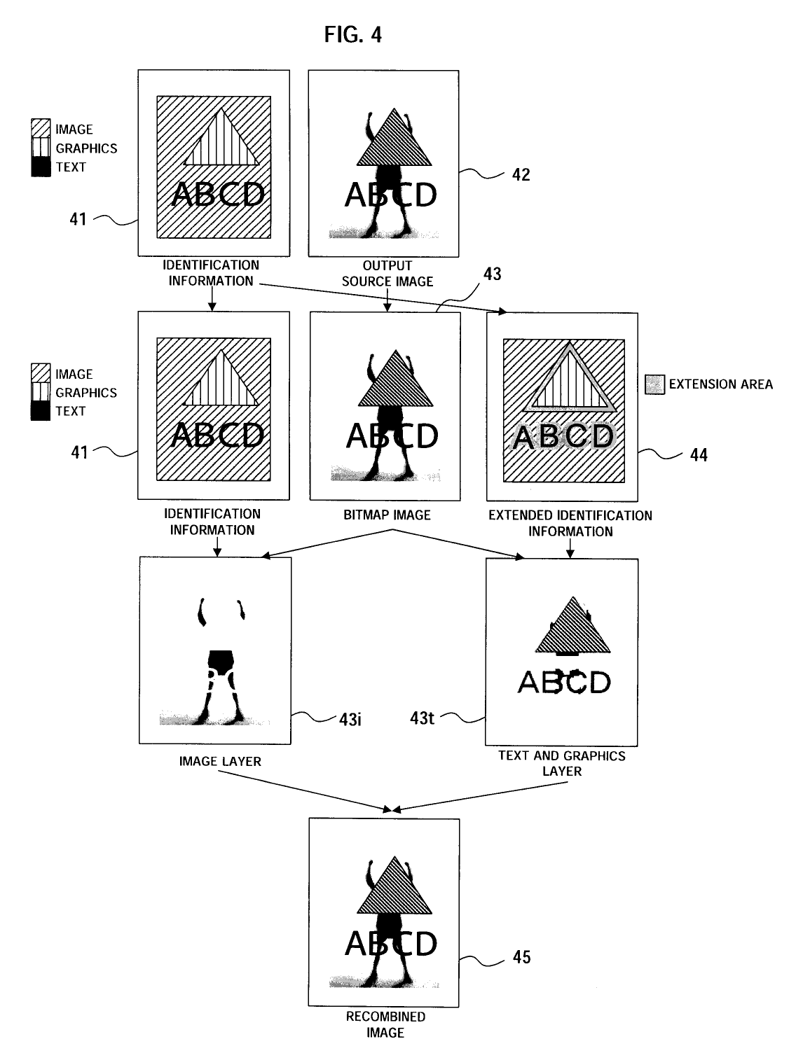

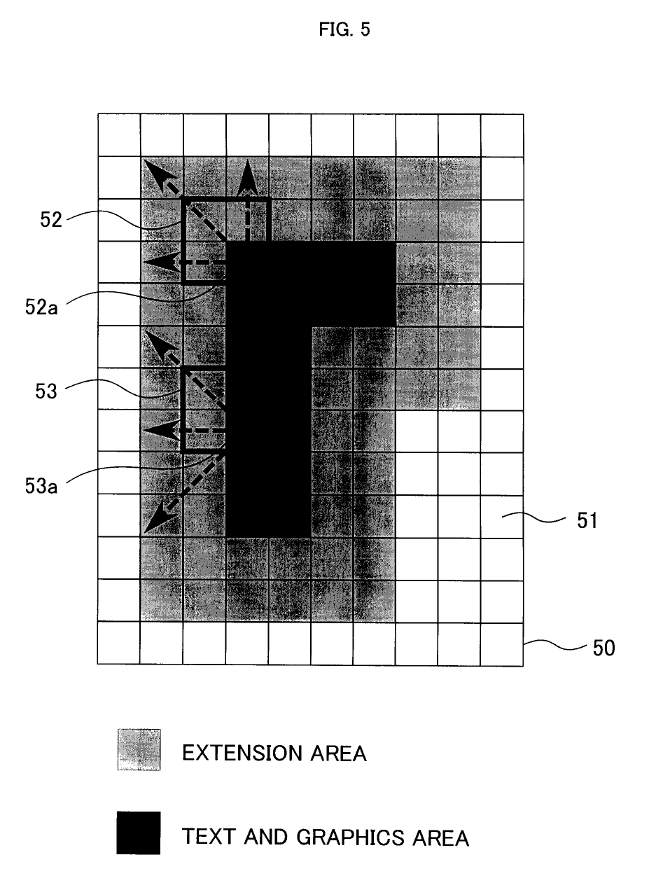

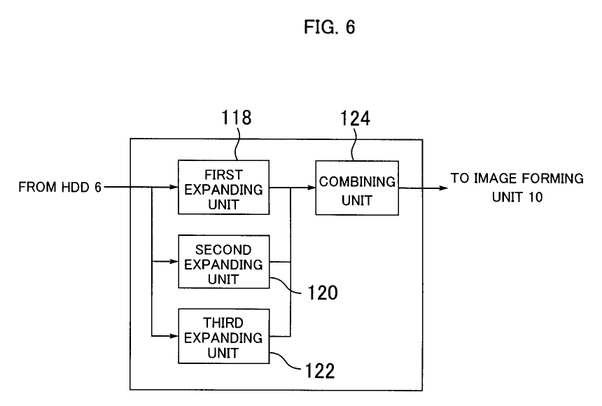

FIGS. 2 and 6 are functional block diagrams for explaining the image processing apparatus 1 according to the first embodiment. FIG. 3 is a detailed functional block diagram concerning a RIP unit among functional blocks shown in FIG. 2. FIG. 4 is a diagram for explaining, by showing examples of images, a flow of image processing performed by the image processing apparatus 1 according to the first embodiment. FIG. 5 is a diagram for explaining extended identification information generation processing performed by the image processing apparatus 1 according to the first embodiment.

As shown in FIGS. 2 and 6, the image processing apparatus 1 according to the first embodiment includes an information acquiring unit 102, a RIP unit 104, an image dividing unit 106, an identification-information extending unit 108, a first compressing unit 110, a second compressing unit 112, a third compressing unit 114, an output unit 116, a first expanding unit 118, a second expanding unit 120, a third expanding unit 122, and a combining unit 124. The image dividing unit 106 and the identification-information extending unit 108 configure a divided-image generating unit.

Processing by the image processing apparatus 1 for finally generating a bitmap image on the basis of a PDL file, performing division of an image, and performing predetermined compression is explained with reference to FIGS. 2 to 5.

The information acquiring unit 102 acquires a PDL file, which is information to be printed, from the terminal 200 via the network 300.

The RIP unit 104 analyzes a PDL file acquired by the information acquiring unit 102, extracts a bitmap image on the basis of the PDL file, and creates identification information by identifying objects included in the PDL file according to types of the objects.

Details of functions of the RIP unit 104 are explained with reference to FIG. 3. As shown in FIG. 3, the RIP unit 104 includes a bitmap-image generating unit 104a and an identification-information extracting unit 104b.

First, the bitmap-image generating unit 104a performs processing for extracting a bitmap image used for image formation (printing) from the acquired PDL file.

The identification-information extracting unit 104b performs processing for analyzing the acquired PDL file and extracting identification information obtained by identifying objects in a page image to be printed. The identification information is information in which, concerning pixels of the bitmap image, objects displayed by the pixels are identified. Therefore, it is possible to specify, by referring to the identification information, to which type of object among image, text, and graphics, for example, a pixel corresponding to a coordinate (x1, y1) of the bitmap image belongs in a file before being bitmapped.

The bitmap image generated by the bitmap-image generating unit 104a is sent to the image dividing unit 106. The identification information is sent to the image dividing unit 106 and the identification-information extending unit 108.

Processing by the functional blocks explained above is explained with reference to FIG. 4. The bitmap-image extracting unit 104a of the RIP unit 104 generates a bitmap image 43 from an output source image 42, which is an original file to be printed. The identification-information extracting unit 104b generates identification information 41. As shown in FIG. 4, the bitmap image 43 and the arrangement of image, text, and graphics objects of the identification information 41 coincide with each other in a page.

Subsequently, the identification-information extending unit 108, which configures the divided-image generating unit, performs processing for extending areas of the text object and the graphics object, which are image areas given with extension areas, of the extracted identification information. Consequently, the identification-information extending unit 108 generates extended identification information in which the areas of the text and graphics objects are extended in a page of the identification information.

Details of the processing for generating extended identification information by the identification-information extending unit 108 are explained with reference to FIG. 5. FIG. 5 is a diagram for explaining extended identification information generation processing performed by the image processing apparatus 1 according to the first embodiment. A page 50 of the identification information is imaginarily displayed by pixels 51. First, the identification-information extending unit 108 detects types of objects in pixel unit in the page 50 of the identification information. Specifically, for example, the identification-information extending unit 108 can specify types of objects concerning all the pixels of the page 50 by performing scanning along lines of the pixels in the left to right direction of the page 50. The identification-information extending unit 108 determines, according to a shape of a contour of a text and graphics area indicated by black, an extension area to which the text and graphics area is extended and extends the text and graphics area to the area.

Specifically, the identification-information extending unit 108 performs pattern matching in a unit of four pixels including pixels forming the contour of the text and graphics area and determines the extension area of the text and graphics area. In other words, the identification-information extending unit 108 determines an extension direction on the basis of an arrangement pattern of pixels of the text and graphics area in the four pixels and pixels of an image area, which are the other pixels in the four pixels.

For example, attention is paid to four pixels 52 including a pixel 52a on the upper left of the text and graphics area. The text and graphics pixel 52a is present on the lower right of the group of four pixels 52. The other pixels, which are not text and graphic pixels, are present on the left of, above, and on the upper left of the pixel 52a. In the case of such an arrangement pattern, in this embodiment, an area is extended in an upper direction, a left direction, and an upper left direction with the pixel 52a set in the center. In the case of the example shown in FIG. 5, the size of the area to be extended with the pixel 52a set in the center is eight pixels.

For example, when an area is extended with respect to a pixel 53a on the left side of the text and graphics area, attention is paid to a group of four pixels 53 and a positional relation of the pixel 53a is examined in the same manner as explained above. In this case, the left side of the pixel 53a is an area that is not a text and graphics area. Therefore, the area is extended in left, upper left, and lower left directions. In this way, patterns of the pixels of the contours of the text and graphics areas are detected and the areas are extended with respect to the pixels of the text and graphics areas, whereby an extension area indicated by gray in FIG. 5 is generated. Identification information obtained by identifying the extension area indicated by gray as the text and graphics area is the extended identification information explained above.

In FIG. 4, a triangular area of graphics and an area of a text ABCD are extended on the basis of the identification information 41. An extended identification information 44 in which sections of the extension area indicated by gray are identified as areas of graphics and a text, respectively, is generated.

The image dividing unit 106, which configures the divided-image generating unit, performs processing for dividing a bitmap image generated by the bitmap-image generating unit 104a of the RIP unit 104 into an image area of an image and an image including an image area of a text and an image area of graphics. Specifically, referring to FIG. 4, the image dividing unit 106 divides the image area of the image from the bitmap image 43 on the basis of the identification information 41. The image dividing unit 106 divides the image area of the text and the image area of the graphics from the bitmap image 43 on the basis of the extended identification information 44. The image dividing unit 106 generates an image of the divided image area of the image on an imaginary image layer and generates an image of the divided image areas of the text and graphics on an imaginary text and graphics layer. In FIG. 4, an image layer 43i on which only the image area of the image is displayed and a text and graphics layer 43t on which the image areas of the text and graphics are displayed are shown. Since the image areas of the text and graphics are divided on the basis of the extended identification information 44, an area (an extension area) crossing a boundary between the area of the text and graphics and the area of the image is also divided as a text and graphics area. In other words, an extension area around the triangle of the area of the graphics and around the area of the text “ABCD” is also identified as a text and graphics area and divided from the bitmap image 43. Therefore, a part of the image area of the image around the area of the text and graphics is cut and generated on the text and graphics layer 43t. In the image on the image layer 43i, since the areas of the text and the graphics are cut, white of a background of the image layer 43i appears in a cut section.

When a bitmap image and identification information separately generated on two layers are temporarily stored in the HDD 6, the first compressing unit 110, the second compressing unit 112, and the third compressing unit 114 perform processing for compressing the bitmap image and the identification information according to compression systems corresponding to characteristics thereof, respectively. The compressing units are explained below.

The first compressing unit 110 compresses an image on the image layer 43i according to an irreversible compression system. With the irreversible compression system, even if an image is formed by image objects with a large number of colors, data compression can be efficiently performed. An image quality can be maintained to a degree enough for making image quality deterioration less conspicuous compared with an original image. As the irreversible compression system, a compression system such as JPEG can be used.

The second compressing unit 112 compresses an image on the text and graphics layer 43t according to a reversible compression system. An image rendered by a text object or a graphics object often has a sharp edge. Therefore, if such an image is compressed by using the irreversible compression system, the edge is blurred, readability of a text of a printed image falls, and the image is deteriorated compared with the original image. Therefore, the image on the text and graphics layer 43t is compressed by using the reversible compression system with less image deterioration such as a blur of an edge. As the reversible compression system, ZIP, LZH, CAB, PNG, MMR, and the like can be used.

The third compressing unit 114 compresses extended identification information according to the reversible compression system. The extended identification information is compressed and temporarily stored in the HDD 6 to be used when bitmap images divided on the image layer 43i and the text and graphics layer 43t and separately compressed are recombined. When a loss occurs in data because of compression, the extended identification information cannot be accurately recombined. Therefore, the extended identification information is compressed by using the reversible compression system. As the reversible compression system, a compression system same as that used by the second compressing unit 112 can be used.

The output unit 116 as a storage control unit performs processing for collecting the pieces of information compressed by the first to third compressing units 110 to 114 in one folder to thereby associate the pieces of information, sends the information to the HDD 6, and causes the HDD 6 to store data.

Details of processing for recombining divided bitmap images temporarily stored in the HDD 6 and outputting the bitmap images to the image forming unit 10 are explained with reference to FIGS. 6 and 4. FIG. 6 is a functional block diagram for explaining data expansion processing and data combination processing performed by the image processing apparatus 1 according to this embodiment.

The first expanding unit 118 performs processing for acquiring image information on the image layer 43i compressed by the first compressing unit 110 from the HDD 6 and expanding the image information. The second expanding unit 120 performs processing for acquiring image information on the text and graphics layer 43t compressed by the second compressing unit 112 from the HDD 6 and expanding the image information. The third expanding unit 122 performs processing for acquiring extended identification information compressed by the third compressing unit 114 from the HDD 6 and expanding the extended identification information.

The combining unit 124 performs processing for recombining, on the basis of the extended identification information, an image on the image layer 43i and an image on the text and graphics layer 43t expanded by the first to third expanding units to generate a recombined image 45. Specifically, the combining unit 124 performs processing for combining the images by superimposing the image layer 43i and the text and graphics layer 43t to coincide with each other in pixel unit in the original bitmap image. However, as explained above, the image areas of the text and the graphics are divided on the basis of the extended identification information. Therefore, if the image areas are superimposed on the image area of the image divided on the basis of the identification information, the section of the extension area overlaps. A blur tends to occur in the overlapping area on the image side when compression is performed. Therefore, concerning the overlapping area, the image on the text and graphics layer side needs to be adopted and displayed in an image after combination.

Therefore, the image processing apparatus 1 according to this embodiment performs processing for i) setting, on the basis of the extended identification information, the image areas of the text and graphics on the text and graphics layer 43t and the extension area of the images areas as a forefront surface and superimposing and combining the image area of the image on the image layer 43i as a layer below the forefront surface or ii) deleting, on the basis of the extended identification information, the overlapping area on the image layer 43i side (around the image area of the text or the graphics) and combining the image on the image layer and the image on the text and graphics layer. In this embodiment, any one of these methods may be used to combine images. However, an optimum method can be selected by taking into account the architecture and a hardware configuration of a computer. The combining unit 124 sends the recombined image to the image forming unit 10. The image forming unit 10 can form an image on a sheet on the basis of the image.

With the image processing apparatus 1 according to the first embodiment, in performing image formation, when images generated on the basis of a PDL file are divided according to types of objects and the images are temporarily stored in the storage area, it is possible to perform processing for compressing the images according to an optimum compression system corresponding to the types of the objects. Therefore, it is possible to perform compression with less deterioration in data while maintaining a high compression ratio. Therefore, it is possible to reduce an image processing load in the image formation in the image processing apparatus 1 and execute smooth image processing and image formation processing.

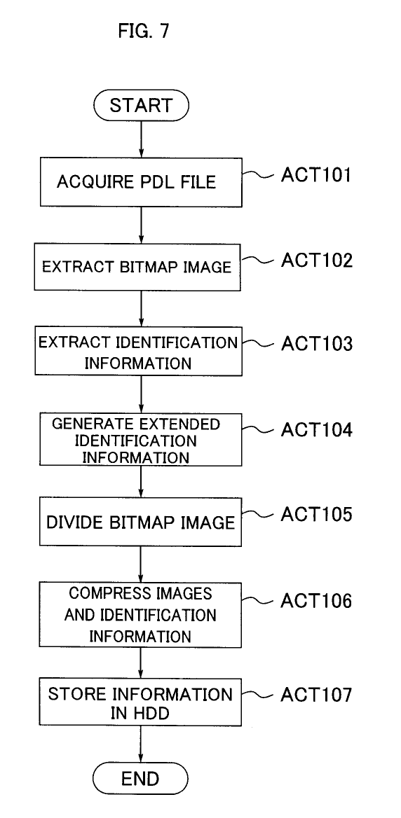

A flow of image processing performed in the image processing apparatus 1 according to the first embodiment is explained below. FIG. 7 is a flowchart of an example of a flow of processing for finally compressing data and temporarily storing the data in the HDD 6 in a flow of processing (an image processing method) executed by the image processing apparatus 1 according to the first embodiment.

First, the terminal 200 converts information, which a user operates to print, into a PDL file and transmits the PDL file to the information processing apparatus 1 via the network 300 as a print job. The information acquiring unit 102 of the image processing apparatus 1 acquires the transmitted PDL file (Act 101).

Subsequently, the bitmap-image extracting unit 104a of the RIP unit 104 analyzes the acquired PDL file and extracts a bitmap image on the basis of the PDL file (Act 102). The extracted bitmap image is sent to the image dividing unit 106.

The identification-information extracting unit 104b analyzes the PDL file and extracts identification information in which an image object, a text object, and a graphics object are identified from one another on an imaginary page (Act 103). As explained above, in the identification information extracted from the PDL file, the objects are identified for each of pixels of the bitmap image. For example, it is possible to specify, according to a type of an object identified in (x1, y1) of the identification information, which type of object in a file before conversion a pixel of (x1, y1) of the bitmap image is. The extracted identification information is sent to the identification-information extending unit 108.

The identification-information extending unit 108 performs processing for extending an area of a text and an area of graphics of the acquired identification information to generate extended identification information (Act 104). A method of extending areas is as explained above. The identification-information extending unit 108 performs processing for scanning contours of areas of text and graphics objects and extending the text and graphics areas in a predetermined direction according to a pattern of the contours.

The image dividing unit 106 performs processing for dividing the acquired bitmap image (Act 105). Specifically, the image dividing unit 106 divides, on the basis of the identification information extracted in Act 103, an image area of the image object from the bitmap image and generates an image of only the image object on an image layer. Further, the image dividing unit 106 divides, on the basis of the extended identification information generated in Act 104, areas of the text and the graphics including the extended areas from the bitmap image and generates the image on a text and graphics layer. According to these kinds of processing, the original bitmap image can be changed to divide images of a section of the image and a section of the text and graphics. The dividing processing may be applied to any one of the image section and the text and graphics section earlier or may be applied to the image section and the text and graphics section in parallel.

The first to third compressing units 110 to 114 perform compression of the data (Act 106). The first compressing unit 110 compresses the image on the image layer according to the reversible compression system. The second compressing unit 112 compresses the image on the text and graphics layer according to the irreversible compression system. The third compressing unit 114 compresses the extended identification information according to the reversible compression system. Specific compression processing is as explained in the explanation of the functional blocks.

The output unit 116 performs processing for temporarily storing the three kinds of information compressed by the first to third compressing units 110 to 114 in the HDD 6 (Act 107). The information stored in the HDD 6 is kept stored in the HDD 6 until the turn for image formation for the information by the image forming unit 10 of the image processing apparatus 1 comes.

Consequently, the image processing apparatus 1 finishes the processing for acquiring a PDL file from the terminal 200, generating divided two bitmap images, applying a compression system optimum for a type of an object to the bitmap images to compress the bitmap images, and temporarily storing the bitmap images in the HDD 6.

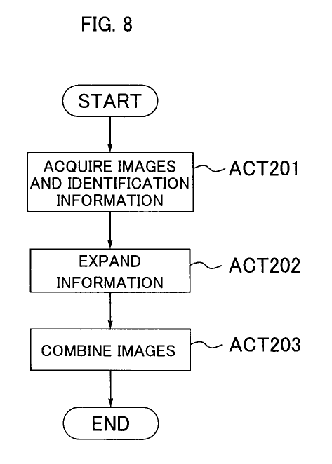

A flow of processing for recombining the information temporarily stored in the HDD 6 and outputting the information to the image forming unit 10 is explained with reference to FIG. 8.

First, concerning the information stored in the HDD 6 in Act 107, when the turn for image formation for the information by the image forming unit 10 comes, the first to third expanding units 118 to 122 respectively acquire three kinds of information (divided bitmap images and the extended identification information) compressed in Act 106 from the HDD 6 (Act 201) and perform processing for expanding the information (Act 202). The first expanding unit 118 expands the image on the image layer compressed by the first compressing unit 110. The second expanding unit 120 expands the image on the text and graphics layer compressed by the second compressing unit 112. The third expanding unit 122 expands the extended identification information compressed by the third compressing unit 114.

Subsequently, the combining unit 124 performs processing for combining the image on the image layer and the image on the text and graphics layer expanded in Act 202 and generating a recombined image (Act 203). Specific combination processing is as explained in the explanation of the functional blocks.

The flow from the expansion processing for the information stored in the HDD 6 until the combination processing for the images is as explained above.

In the flowchart shown in FIG. 7, the processing for extracting a bitmap image (Act 102) and the processing for generating identification information and extended identification information (Act 103 and Act 104) do not need to be performed in the order shown in FIG. 7. These kinds of processing may be performed in opposite order or may be performed in parallel.

In this embodiment, the extension areas are given to the image areas of the text and the graphics and the section of the image on the image layer in which a blur occurs is replaced with the extension area of the text and graphics to generate a combine image. However, image areas given with extension areas are not limited to this. An area of the image of the identification information may be extended to give the extension area to the image area of the image or extension areas may be given to both the image areas of the image and the text and graphics. In both the cases, the edge section of the image area of the image where a blur tends to occur overlaps an image of the text and graphics. Therefore, it is possible to generate a combined image without a blur by adopting the image of the text and graphics subjected to the reversible compression processing in an overlapping section.

As explained above, with the image processing apparatus 1 and the image processing method according to the first embodiment, it is possible to divide a bitmap image generated on the basis of a PDL file in image formation and divided on the basis of identification information concerning types of objects (image, text, and graphics) extracted from the PDL file and compress and temporarily store the bitmap image according to an optimum compression system corresponding to the types of the objects. Consequently, it is possible to compress an image at a high compression ratio while preventing deterioration in an image.

### Second Embodiment

A second embodiment of the present invention is explained. In the second embodiment, the image processing apparatus 1 performs processing for selecting, on the basis of a predetermined condition, the irreversible compression system or the reversible compression system as a compression system for divided images on an image layer and performing processing for compressing the images. In the first embodiment, any kind of image data is compressed by the irreversible compression system in order to maintain compression efficiency. However, the second embodiment is different from the first embodiment in that, when image data can be efficiently compressed even if the reversible compression system is used, the image data is compressed by the reversible compression system. Details of the second embodiment are explained below. However, explanation of components same as those in the first embodiment is omitted.

The system configuration of the image processing apparatus 1 shown in FIG. 1 and the functional blocks shown in FIGS. 2, 3, and 6 in the first embodiment are the same in the image processing apparatus 1 according to the second embodiment. Therefore, explanation of the system configuration and the functional blocks is omitted.

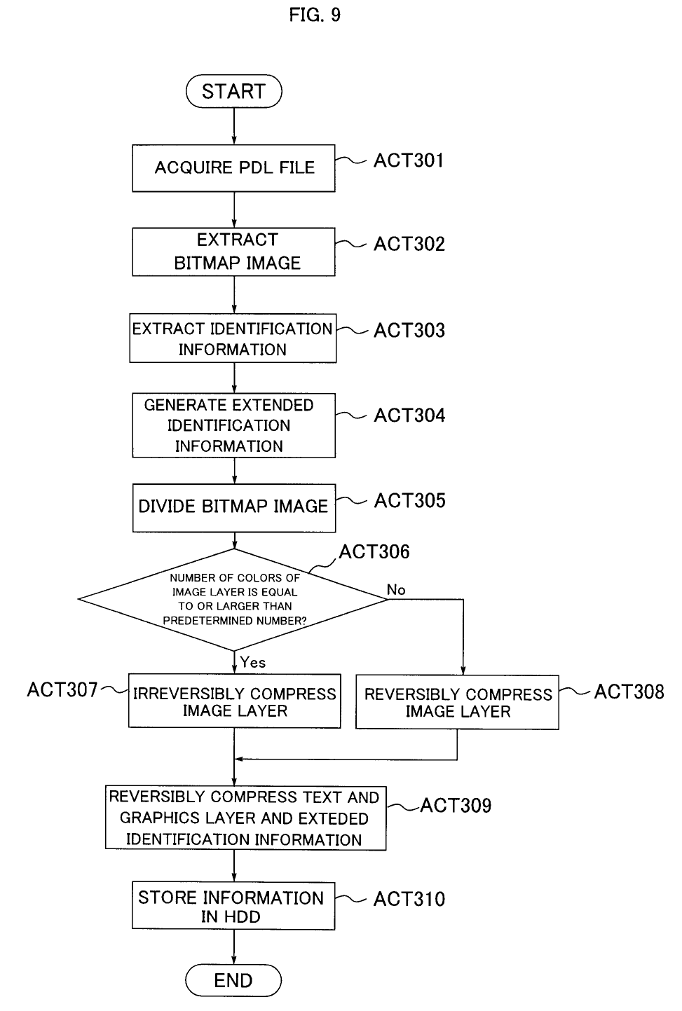

A flow of image processing performed in the image processing apparatus 1 according to the second embodiment is explained with reference to FIG. 9. FIG. 9 is a flowchart of an example of a flow of processing (an image processing method) by the image processing apparatus 1 according to the second embodiment for finally dividing a bitmap image, compressing the divided images, and temporarily storing the images in the HDD 6.

Processing in Act 301 to Act 305 in FIG. 9 is the same as the processing in Act 101 to Act 105 in FIG. 7.

After Act 305, the first compressing unit 110 determines whether the number of colors of an image on an image layer is equal to or larger than a predetermined number (Act 306). When the number of colors is equal to or larger than the predetermined number, the first compressing unit 110 irreversibly compresses the image on the image layer in the same manner as the first embodiment (Act 307). On the other hand, when the number of colors is smaller than the predetermined number, the first compressing unit 110 compresses the image on the image layer according to the reversible compression system (Act 308).

Usually, in the case of an image such as a photograph, since the number of colors and gradations of colors are large, a compression ratio is low even if the reversible compression system is used. Therefore, for an image with a large number of colors, it is preferable to use the irreversible compression system with a higher compression ratio. On the other hand, for example, a uniform image with a small number of colors and a small change in luminance has high redundancy and can be efficiently compressed even by the reversible compression system. Therefore, in such a case, the reversible compression system is used for the image on the image layer.

As a method of determining which of the reversible compression system and the irreversible compression system should be used, the first compressing unit 110 creates a histogram of colors concerning the image on the image layer, calculates the number of colors on the basis of a degree of dispersion of colors, and determines whether the number of colors is equal to or larger than the number of colors set in advance. The first compressing unit 110 determines a compression system on the basis of whether the number of colors is equal to or larger than the predetermined number. The number of colors can be set to, for example, 1, 2, 4, 16, 24, 32, or 64.

In this embodiment, the first compressing unit 110 performs the determination concerning the number of colors of the image on the image layer. However, the determination is not limited to this. For example, it is also possible that the image dividing unit 106, the RIP unit 104, or the like calculates the number of colors of the image on the image layer and the first compressing unit 110 selects reversible compression or irreversible compression on the basis of the information and performs compression processing.

The second compressing unit 112 reversibly compresses an image on a text and graphics layer and the third compressing unit 114 reversibly compresses the extended identification information (Act 309). This processing is the same as that in the first embodiment. The output unit 116 performs processing for temporarily storing the compressed image on the image layer, the compressed image on the text and graphics layer, and extended identification information in the HDD 6 (Act 310).

Consequently, the image processing apparatus 1 according to the second embodiment finishes the processing for selecting a compression system for the image on the image layer, compressing the image, and temporarily storing compressed data in the HDD 6.

Expansion processing for the compressed data and processing for generating a recombined image are the same as those in the first embodiment. However, the image on the image layer is compressed according to the reversible compression system or the irreversible compression system. Therefore, the first expanding unit 118 performs expansion processing according to the reversible compression system or the irreversible compression system.

With the image processing apparatus 1 according to the second embodiment, it is possible to select an optimum compression system according to the number of colors of the image on the image layer. Therefore, in the case of an image with a smaller number of colors for which a high compression ratio can be secured even by the reversible compression system, it is possible to apply the reversible compression system to the image and realize satisfactory compression processing with little deterioration in data.

### Third Embodiment

A third embodiment of the present invention is explained. The image processing apparatus 1 according to the third embodiment performs extended identification information generation processing according to a method different from that in the first embodiment. Specifically, in generating extended identification information, the identification-information extending unit 108 scans identification information from the left to right (or from the right to left) line by line and performs the scanning in order from an upper line to a lower line (or from a lower line to an upper line). When a pixel of attention in the scanning changes from a pixel of an image area of an image to a pixel of an image area of text and graphics, the identification-information extending unit 108 performs processing for extending an area of predetermined size as a text and graphics area with a pixel of the text and graphics set as the center. In addition to the change in the type of the information concerning the left and right pixels, when a pixel in the same position in an immediately preceding line of a pixel of the text and graphics of attention is a pixel of different data, i.e., a pixel of image data, the identification-information extending unit 108 also performs the processing for extending the area of predetermined size with the pixel of the text and graphics of attention set as the center.

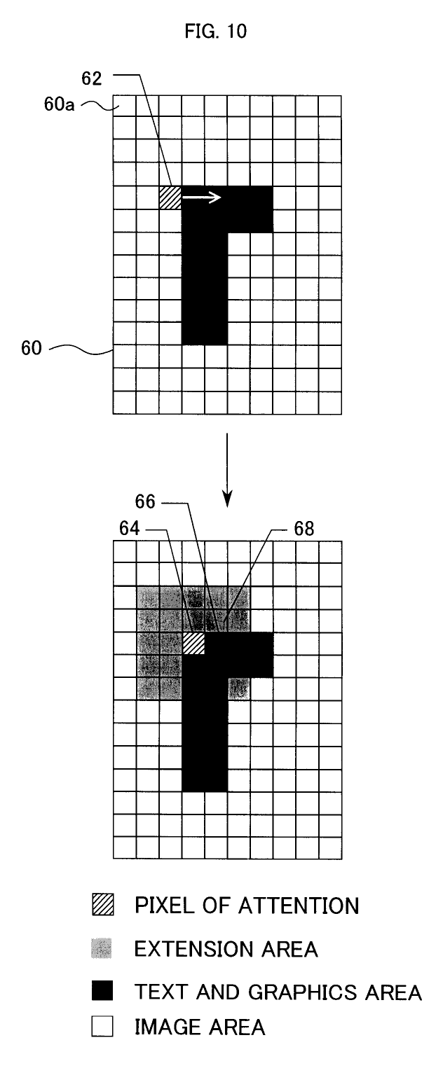

Extended identification information generation processing according to the third embodiment is explained below with reference to FIG. 10. In FIG. 10, scanning is performed for all pixels of a screen 60 by processing for starting scanning from a pixel 60a at an upper left corner of the screen 60 in the right direction and, when the scanning for one line is finished, shifting a scanning line to a line right below the line and repeating the scanning. When a pixel of attention moves from a pixel 62 of an image area of an image to a pixel 64 of an image area of text and graphics, processing for extending a text and graphics area with the pixel 64 of the text and graphics set as the center is performed.

When the pixel of attention in the scanning moves to a pixel 66 further on the right, in a relation with the immediately preceding pixel 64, the pixel 66 is a pixel of the same object (text and graphics). However, a pixel 68 in the same position in the immediately preceding scanning line is a pixel of the image. In this case, the processing for extending the text and graphics area is performed with the pixel 66 of the text and graphics set as the center. Extended identification information in which the text and graphics area is extended is generated by applying such scanning and extension processing to respective lines in order.

In the case of the example shown in FIG. 10, an area to be extended is an area of 5×5 pixels around the pixel of attention of the text and graphics. However, in the case of actual processing in the image processing apparatus 1, 9×9 pixels or 17×17 pixels are preferable as an area of predetermined size to be extended. This is because, since encoding is performed in a unit of 8×8 or 16×16 pixels in JPEG as a main irreversible compression processing for image data, it is possible to cover a blur of an edge on the image layer side with an extension area on the text and graphics layer side in combination of images by extending the text and graphics area in an area larger than the unit pixels.

In this embodiment, the extension processing is performed on the basis of a relation in types of objects among a scanned immediately preceding pixel, a present pixel of attention, and a pixel in the same position in the immediately preceding scanning line. However, the extension processing is not limited to this. For example, the extension processing may be performed on the basis of a relation of the pixel of attention to pixels above and below and on the left and right of the pixel of attention. The size of the area to be extended is not limited to the size explained above. The size can be appropriately changed to optimum size according to the performance of the image processing apparatus 1 and characteristics of an image to be processed.

### Fourth Embodiment

A fourth embodiment of the present invention is explained. In the fourth embodiment, when the image on the image layer is compressed in the image processing explained in the first to third embodiments, processing for filling a section cut as an image area of the text and graphics (e.g., a white void section of the image layer 43i shown in FIG. 4) with an image of a peripheral image area of the image is performed.

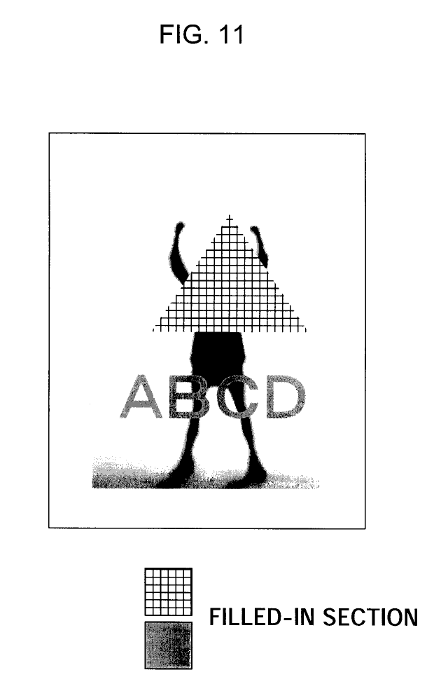

In FIG. 11, an image example in which a text and graphics area of a bitmap image on an image layer is filled with a peripheral image is shown. In this way, an image on the image layer is filled with the peripheral image rather than leaving the image left as white void. This makes it possible to reduce a sudden change in colors near a boundary between a cut white void area and an image area of the image. Consequently, there is an effect that it is possible to improve a compression ratio of the image on the image layer.

On the other hand, when the white void section is compressed in that state, a change in colors near the boundary is large and the compression ratio may fall.

As processing for filling a section cut as an image area of the text and graphics, an image complementing unit that performs filling processing may be provided anew or the filling processing may be performed by the image dividing unit 106 or the first compressing unit 110. The filling processing can be performed between Act 105 and Act 106 in FIG. 7 explained in the first embodiment.

### Fifth Embodiment

A fifth embodiment of the present invention is explained. In the fifth embodiment, after dividing a bitmap image created on the basis of a PDL file, concerning an image on an image layer, the image processing apparatus 1 applies, to an area as a cut image area of text and graphics, processing for extending an image area crossing a boundary between the image area and the area. Therefore, the fifth embodiment is different from the first embodiment in extending an area of an image itself rather than extending identification information. Explanation of configuration same as those in the first embodiment is omitted.

In this embodiment, an “image area of an image” and an “image area of text and graphics” mean original areas of an image and text and graphics in a bitmap image. An “image area” and a “text and graphics area” mean areas in an image on an image layer.

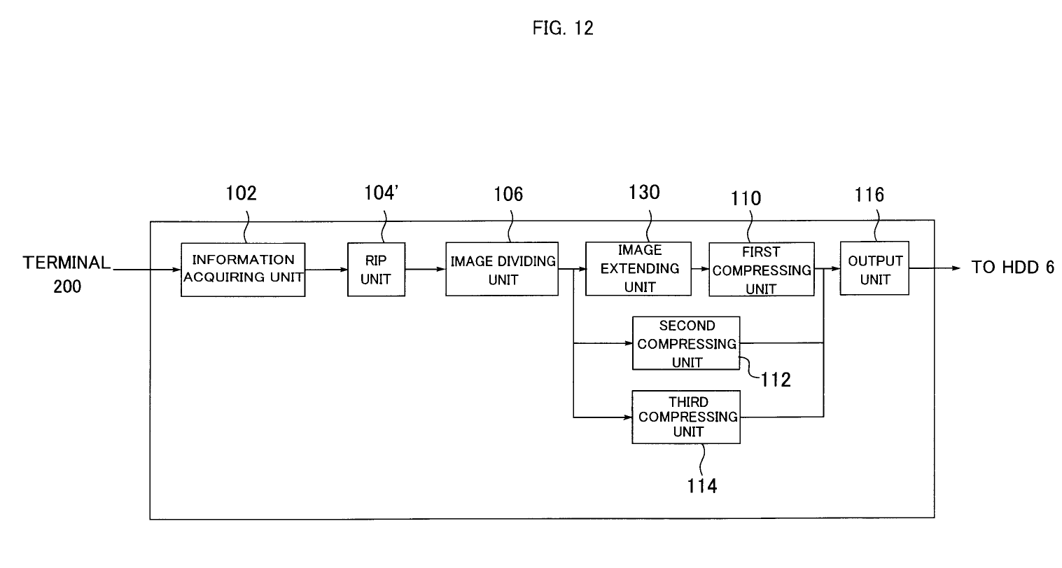

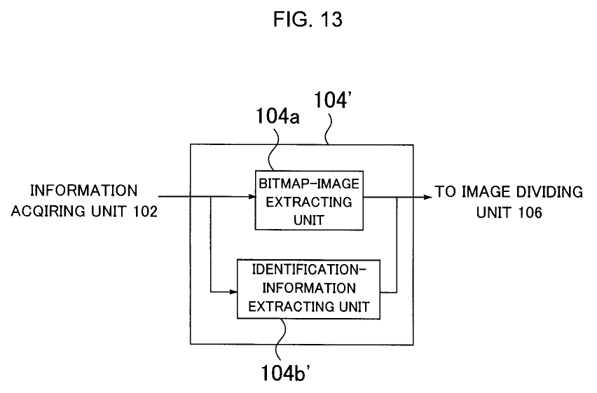

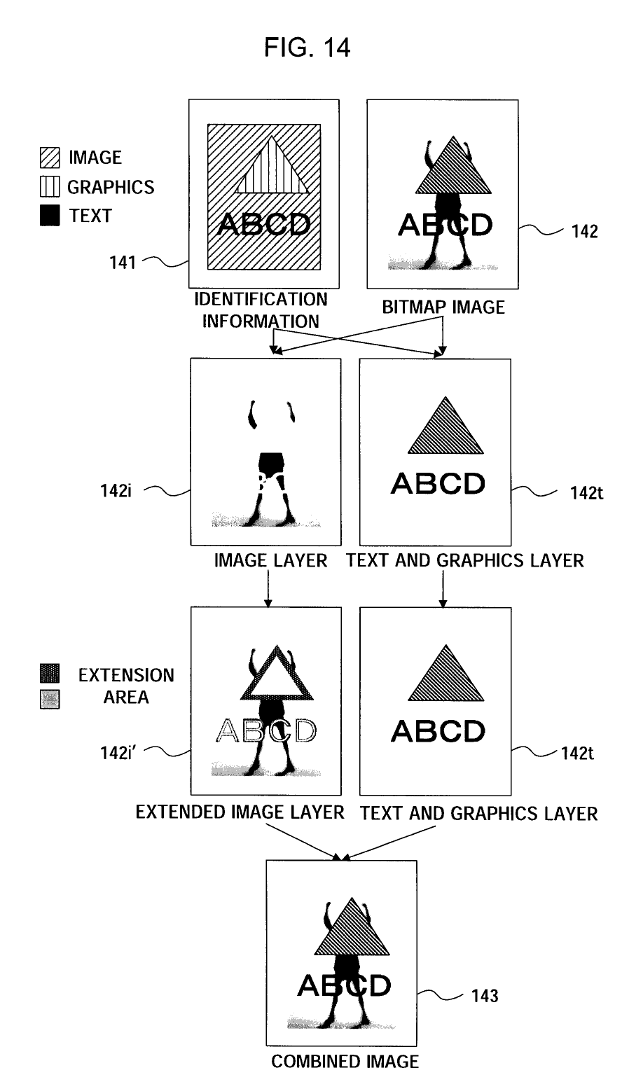

Details of image processing by the image processing apparatus 1 according to the fifth embodiment are explained with reference to FIGS. 12 to 14. FIG. 12 is a functional block diagram for explaining the image processing apparatus 1 according to the fifth embodiment. FIG. 13 is a functional block diagram for explaining details of functions of a RIP unit 104′. FIG. 14 is a diagram for explaining, by showing examples of images, a flow of image processing performed by the image processing apparatus 1. In this embodiment, the image dividing unit 106 and an image extending unit 130 configure a divided-image generating unit. A configuration and a system configuration of the image processing apparatus 1 are the same as those shown in FIG. 1 in the first embodiment. Therefore, explanation of the configuration and the system configuration is omitted.

As in the first embodiment, the information acquiring unit 102 acquires a PDL file from the terminal 200 as a print job. As in the first embodiment, the RIP unit 104′ generates a bitmap image and identification information of the bitmap image on the basis of the acquired PDL file. However, as shown in FIG. 13, the RIP unit 104′ in the fourth embodiment is different from that in the first embodiment in that identification information extracted by an identification-information extracting unit 104b′ is sent to only the image dividing unit 106.

The image dividing unit 106, which configures the divided-image generating unit, divides the bitmap image into an image area of an image and an image area of text and graphics on the basis of the identification information generated by the RIP unit 104′. The image dividing unit 106 pastes the image area of the image to an image layer and pastes the image area of the text and graphics to a text and graphics layer. In FIG. 14, a bitmap image 142 is divided on the basis of identification information 141. Images corresponding to the respective image areas are generated on an image layer 142i and a text and graphics layer 142t.

The image extending unit 130, which configures the divided-image generating unit, applies, to the image area of the image generated on the image layer, processing for giving an extension area to an area cut as the image area of the text and graphics from the image area of the original image before the division and extending the area crossing a boundary between both the image area of the image and the image area of the text and graphics.

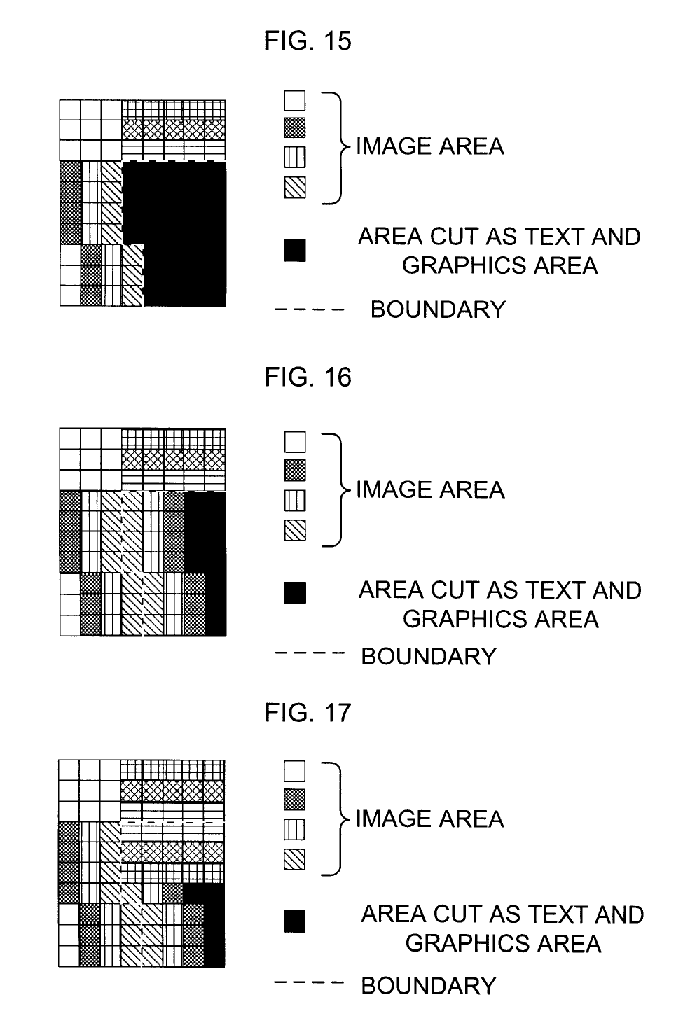

Details of extension processing for an image on the image layer in the fourth embodiment are explained with reference to FIGS. 15 to 17. FIGS. 15 to 17 are diagrams for explaining, by showing a part of a bitmap image on the image layer, processing for extending an image area. In FIGS. 15 to 17, an area indicated by black is an area cut as an image area of text and graphics (a text and graphics area) by dividing the image. All the other pixels are an image area of an image. A broken line between the image area and the text and graphics area indicates a boundary between both the areas. In the image processing apparatus 1 according to this embodiment, first, the image extending unit 130 specifies the boundary between the image area of the image and the image area of the text and graphics in the bitmap image on the basis of identification information. The image extending unit 130 scans the bitmap image on the image layer line by line of pixels in a left to right direction and an up to down direction. As shown in FIGS. 15 and 16, in the scanning in the left to right direction, the image extending unit 130 copies pixels of the image area to the text and graphics area side to perform extension processing for the image area. Specifically, the image extending unit 130 copies three pixels of the image area on the left side of a boundary line in the vertical direction and pastes the pixels on the text and graphics area side on the right side to be line-symmetrical to the boundary line set as a symmetry axis. Consequently, pixels in a fixed range in the left to right direction are line-symmetrical with respect to the boundary line. When the scanning and the extension processing in the left to right direction are completed, the image extending unit 130 performs scanning and extension processing in the up to down direction. The extension processing in the up to down direction is the same as that in the left to right direction. The image extending unit 130 copies pixels in the image area to the text and graphics area side with a boundary line in the horizontal direction set as a symmetry axis. Since the scanning and the copying in the up to down direction are performed after the processing in the left to right direction, among pixels redundantly pasted, pixels generated in the copy processing in the up to down direction are displayed.

According to the extension processing explained above, as shown in FIG. 17, an area near the boundary of the text and graphics area is filled with pixels of the image area around the area. Consequently, an image in which the image area is extended can be generated.

As explained above, with the image processing apparatus 1 according to the fifth embodiment, an extension area can be given to the image area of the image by copying the pixels of the image area to the area cut as the image area of the text and graphics and extending the area. Consequently, there is an effect that a blur that occurs near the boundary between the image area of the image and the image area of the text and graphics in the image on the image layer can be relaxed.

An edge as a characteristic of the text and graphics occurs in a section cut as the image area of the text and graphics. Therefore, a blur tends to occur in the section during compression processing. However, as in this embodiment, a sudden change in colors that occurs across the boundary between both the areas can be relaxed by filling the text and graphics area near the boundary with pixels same as the pixels of the image area around the area. Therefore, the effect explained above is obtained. Concerning the section extended to the text and graphics area side, a combined image explained later does not change from the original bitmap image if pixels of the image on the text and graphics layer side to be reversibly compressed are adopted in the combined image.

According to such image extension processing, in FIG. 14, an extended image layer 142i′ is generated on which an image including the image area of the image layer 142i extended to the text and graphics area side is generated.

In the explanation referring to FIGS. 15 to 17, the copy processing for the image area is performed for three pixels. However, in actual image processing in the image processing apparatus 1, it is preferable to copy an image area for eight pixels. This is because, since encoding is usually performed in a unit of 8×8 pixels in JPEG as a main irreversible compression system for image data, by extending an area for eight pixels, it is possible to sufficiently suppress a blur and deterioration near a boundary between the area and the text and graphics area of the image on the image layer.

The first to third compressing units 110 to 114 perform processing for compressing data as in the first embodiment. The first compressing unit 110 performs processing for compressing an image on an extended image layer, in which an image area is extended, generated by the image extending unit 130 according to the irreversible compression system. The second compressing unit 112 performs processing for compressing an image on the text and graphics layer according to the reversible compression system in which a blur of an edge less easily occurs. The third compressing unit 114 performs processing for compressing identification information according to the reversible compression system.

The output unit 116 performs processing for temporarily storing the pieces of information compressed by the first to third compressing units 110 to 114 in the HDD 6 in association with each other until the turn for a print job for the information by the image forming unit 10 comes.

Expansion processing for compressed data and combination processing for an image on the image layer and an image on the text and graphics layer are executed by the functional blocks shown in FIG. 6 in the first embodiment. However, the fourth embodiment is different from the first embodiment in that, since division of an image is performed on the basis of identification information (rather than extended identification information), the combination processing for images is performed by using the identification information. Consequently, in FIG. 14, a combined image 143 in which the extended image layer 142i′ and the text and graphics layer 142t are combined is obtained.

With the image processing apparatus 1 according to the fifth embodiment explained above, as in the first embodiment, it is possible to divide, on the basis of identification information extracted from a PDL file, a bitmap image generated on the basis of the PDL file in image formation and compress the bitmap image according to optimum compression systems corresponding to types of objects. This makes it possible to compress data at a high compression ratio while preventing deterioration in an image and the like. Compared with the first embodiment, in dividing the bitmap image, the image is simply divided on the basis of one piece of identification information. Therefore, there is an advantage that a load of image division processing is small.

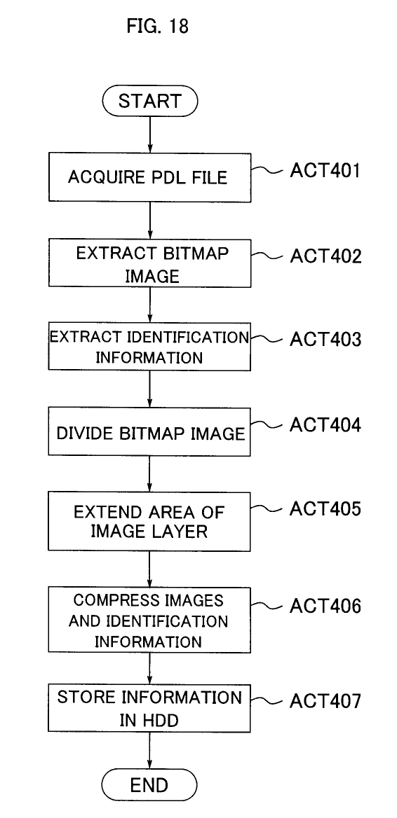

A flow of image processing performed in the image processing apparatus 1 according to the fifth embodiment is explained. FIG. 18 is a flowchart of an example of a flow of processing for finally compressing data and temporarily storing data in the HDD 6 in a flow of processing (an image processing method) executed by the image processing apparatus 1 according to the fifth embodiment.

Act 401 to Act 403 are the same as Act 101 to Act 103 in the first embodiment. The information acquiring unit 102 acquires a PDL file and the RIP unit 104′ performs processing for extracting a bitmap image and identification information.

The image dividing unit 106 performs processing for dividing the bitmap image (Act 404). Details of the division processing are as explained above. The image dividing unit 106 divides, on the basis of the identification information, the bitmap image into an image area of an image and an image area of text and graphics and forms images on an image layer and a text and graphics layer, respectively.

The image extending unit 130 performs processing for extending the image area on the image layer (Act 405). First, the image extending unit 130 analyzes the identification information to specify a boundary between the image area of the image and the image area of the text and graphics. The image extending unit 130 performs, concerning the bitmap image on the image layer, extension processing for the image area by copying pixels of the image area from the image area side to the text and graphics area side with the specified boundary set as a symmetry axis. Details of the extension processing are as explained in the explanation of the functional blocks.

The first to third compressing units 110 to 114 perform processing for compressing data (Act 406). The first compressing unit 110 performs, according to the irreversible compression system, processing for compressing the image on the image layer in which the image area is extended. The second compressing unit 112 performs processing for compressing the image on the text and graphics layer according to the reversible compression system. The third compressing unit 114 performs processing for compressing the identification information according to the reversible compression system.

The output unit 116 performs processing for storing the compressed data in the HDD 6 in association with each other (Act 407).

The flow of the processing for finally compressing the data and temporarily storing the data in the HDD 6 is explained above.

Since processing for expanding and combining images is the same as that in the first embodiment, explanation of the processing is omitted. However, as explained above, in the fifth embodiment, the image combination processing is performed on the basis of identification information rather than extended identification information. In other words, it is possible to combine images according to a method of setting, on the basis of the identification information, an image area of text and graphics of a text and graphics layer as a forefront surface and arranging an image area of an image layer below the forefront surface to combine the image areas or deleting, on the basis of the identification information, an overlapping section of an image on the image layer in which the image area is extended and an image on the text and graphics layer to combine the images. Consequently, in FIG. 14, it is possible to obtain a combined image 143 with less image deterioration in which a blur of an edge of an object of the text and graphics is suppressed.

In the above flowchart, the bitmap image generation processing (Act 402) and the identification information generation processing (Act 403) may be performed in opposite order or may be performed in parallel.

In the explanation of this embodiment, the area is extended concerning the image on the image layer. However, the extension of an area is not limited to this. A text and graphics area of the text and graphics layer may be extended according to the same extension method. However, in this case, since the extended text and graphics area is directly adopted in a combined image, the combined image does not completely coincide with the original bitmap image. Therefore, it is preferable to use the extension method when such a change in the image is allowed.

In the explanation of this embodiment, the pixels are copied and pasted to be line-symmetrical to the pixels of the image area to generate an extension area. However, the generation of an extension area is not limited to this. For example, pixels of the image area adjacent to a boundary between the image area and the text and graphics area may be directly pasted to the text and graphics area side for eight pixels. With such an extension method, when a change in a color value near the boundary on the image area side is large, it is possible to reduce the change in the color value and suppress a blur of an edge by setting pixels of the extension area line-symmetrical to the image area side.

It is also possible to apply the method of changing a compression system for the image layer according to the number of colors of an image on the image layer explained in the second embodiment to an image processing method according to the fifth embodiment. In this case, in the flowchart of FIG. 18 for explaining the flow of the processing in the fifth embodiment, it is possible to apply the method according to the second embodiment by replacing Act 406 with Act 306 to Act 309 of the flowchart in FIG. 9. Consequently, in the case of a uniform image with a small number of colors, it is possible to generate compressed data with less data loss and a high compression ratio by applying reversible compression to the image on the image layer.

### Sixth Embodiment

A sixth embodiment of the present invention is explained. The sixth embodiment is a modification of processing for copying pixels of an image area to an area cut as an image area of text and graphics and extending the area in the image processing method explained in the fifth embodiment.

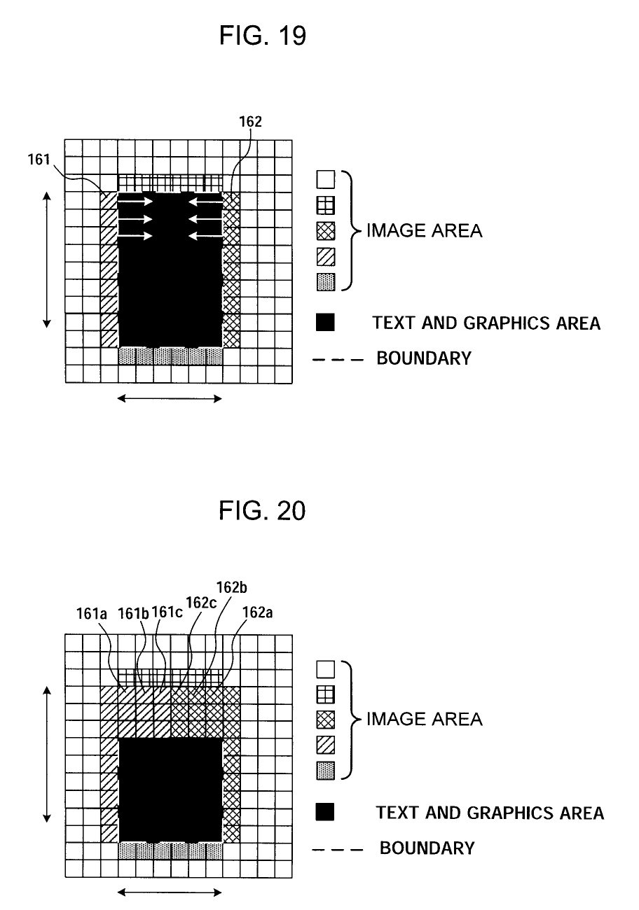

Processing performed by the image processing apparatus 1 according to the sixth embodiment is explained below with reference to FIGS. 19 and 20. FIGS. 19 and 20 are diagrams for explaining processing for extending an image area according to the sixth embodiment. A part of a bitmap image on an image layer is schematically shown in the figures. In this embodiment, the image extending unit 130 shown in FIG. 12 scans identification information in the left to right direction and the up to down direction line by line of each of pixels and specifies an image area of the text and graphics. For example, as shown in FIG. 19, when there is a rectangular image area of the text and graphics, the image extending unit 130 determines which of the length in the up to down direction and the length in the left to right direction is longer. In the case of the rectangular image area of the text and graphics shown in FIG. 19, the image extending unit 130 determines that the length in the up to down direction is longer. In this case, the image extending unit 130 copies, in an image on the image layer, pixels in image areas adjacent to a boundary line on both sides in the vertical direction and pastes the pixels to a text and graphics area in the left to right direction. According to such processing, the image extending unit 130 performs processing for filling the text and graphics area with the pixels of the image areas adjacent to the boundary. Specifically, in FIGS. 19 and 20, the image extending unit 130 copies a pixel 161 and a pixel 162 on both sides of the text and graphics area adjacent to the boundary in the vertical direction and pastes the pixels until the text and graphics area on an inner side is entirely filled with the pixels. Therefore, three pixels 161 are pasted in the right direction in the figure and three pixels 162 are pasted in the left direction in the figure. As a result, as shown in FIG. 20, the text and graphics area in a line in the left to right direction is filled with pixels 161a to 161c same as the pixel 161 and pixels 162a to 162c same as the pixel 162. The image extending unit 130 performs this processing in order from up to down line by line in the left to right direction.

The image extending unit 130 determines the length in the left to right direction and the length in the up to down direction of the image area of the text and graphics and pastes pixels in a direction perpendicular to the direction in which the length is larger. This is because, in general image data, as a distance between pixels opposed to each other across an image area of text and graphics (e.g., the pixel 161 and the pixel 162 in FIG. 19) is larger in one line in the left to right direction or the up to down direction, a change in colors of both the pixels tends to be large. In other words, in image data with a large number of colors such as a photograph, if the two pixels are close to each other, the colors are highly likely to be the same or similar colors. However, if the two pixels are apart from each other, the colors are highly likely to be different colors. Therefore, by filling the text and graphics area with pixels having colors that are highly likely to be similar to each other, it is possible to reduce a change in colors in a boundary in a filled section (in FIG. 20, between the pixel 161c and the pixel 162c). Consequently, there is an effect that, when the image on the image layer processed in this way is irreversibly compressed, it is possible to suppress deterioration and a blur in the image on the image layer.

In FIG. 20, both the number of the pixels 161 and the number of the pixels 162 that fill the text and graphics area are three. However, when the text and graphics area cannot be filled with the same number of the pixels 161 and the pixels 162, any one of the pixels 161 and the pixels 162 may be copied and pasted. It is also possible to determine in advance which of the pixels 161 and the pixels 162 should be copied in the up to down direction and the left to right direction, respectively.

A flow of image processing according to this embodiment is the same as that shown in FIG. 18 in the fifth embodiment. However, in Act 405, the image extending unit 130 performs processing using the image area extending method explained in the sixth embodiment. Since data compression processing, expansion processing, and combination processing after that are the same as those in the fifth embodiment, explanation of these kinds of processing is omitted.

According to the method of extending an image in an image layer explained above, there is an effect that, even when a text and graphics area of a complicated shape is cut in the division of the image, it is possible to improve a compression ratio of the image on the image layer by complementing the cut area with pixels around the area.

A computer program for causing a computer that configures the image processing apparatus 1 to execute the operations explained in the first to sixth embodiments can be provided as an image processing program. In the examples explained in the first to sixth embodiments, the computer program for realizing the functions for carrying out the present invention is recorded in advance in the storage area provided in the apparatus. However, the same computer program may be downloaded from a network to the apparatus. Alternatively, the same computer program stored in a computer-readable recording medium may be installed in the apparatus. The recording medium may be a recording medium of any form as long as the recording medium can store the computer program and the computer can read the recording medium. Specifically, examples of the recording medium include internal storage devices mounted in a computer such as a ROM and a RAM, portable recording media such as a CD-ROM, a flexible disk, a DVD disk, a magneto-optical disk, and an IC card, a database that stores a computer program, other computers and databases for the computers, and a transmission medium on a line. The functions obtained in advance by installation and download in this way may be realized in cooperation with an OS (operating system) in the apparatus.

The computer program in the embodiments includes a computer program from which an execution module is dynamically generated.

In the above explanation, the image on the image layer is irreversibly compressed and the image on the text and graphics layer is reversibly compressed. However, the present invention is not limited to this. When the number of colors of graphics is extremely large and the image cannot be compressed at a high compression ratio by reversible compression, the image may be irreversibly compressed. In this case, the image is divided into an image including image areas of an image and graphics and an image including an image area of only a text. Further, a number-of-colors detecting unit that detects the number of colors from information included in a PDL file may be provided to detect the number of colors concerning objects of an image and graphics and select irreversible compression or reversible compression.

In the above explanation, identification information is generated from the operator of the page description language. However, the number of colors of a bitmap image may be analyzed to generate identification information in which an image area as a target of reversible compression and an image area as a target of irreversible compression are identified.

In the above explanation, the image processing method executed when a PDL file of one page is acquired is explained. However, when the image processing apparatus 1 acquires a PDL file of plural pages, the image processing method according to the present invention can be executed in the same manner by performing processing such as analysis of the PDL file, generation of a bitmap image, division of an image, and compression of the image in order of each of the pages.

In the example explained above, the PDL file (an output source image) includes the areas of the image and the text and graphics. However, when a file of only an image or a file of only any one of text and graphics or both is processed, it is unnecessary to divide a bitmap image. Therefore, it goes without saying that image formation can be performed by performing compression processing corresponding to characteristics of data without performing area extension processing.

In the explanation of the embodiments, the image processing apparatus 1 integrally includes the function of acquiring a PDL file, the function of extracting a bitmap image and identification information, the function of dividing the bitmap image, the function of giving an extension area, the function of compressing a divided image, a function of expanding compressed data, and the function of combining the expanded data. However, the present invention is not limited to this. The functions may be distributed to plural apparatuses if essential requirements of the image processing apparatus according to the present invention are satisfied in a system as a whole and the functions are realized. For example, the system may be a system in which the functions from the acquisition of a PDL file to data compression processing and the functions of expanding the compressed data and combining images are provided in divide apparatuses.

The present invention has been explained in detail with reference to the specific forms. However, it would be obvious to those skilled in the art that various modifications and alterations can be made without departing from the spirit and the scope of the present invention.

As explained above in detail, according to the present invention, it is possible to provide a technique for generating an image used for image formation by processing with less image deterioration when a page image including plural kinds of objects is formed in an image processing apparatus such as a MFP.

What is claim is:

1. An image processing apparatus comprising:
an information acquiring unit that acquires page information concerning a page, for which image formation is performed, described in page description language;
an image extracting unit that extracts a bitmap image on the basis of the page information acquired by the information acquiring unit;
an identification-information extracting unit that extracts, on the basis of the page information, identification information for identifying types of objects included in the page information and identifying to which objects respective pixels of the bitmap image correspond;
a divided-image generating unit that generates, on the basis of the identification information, a first image including a first image area in the page and a second image including a second image area different from the first image area, the divided-image generating unit generating at least one of the images as an image given with an extension area crossing a boundary between an image area corresponding to the image and the other image area;
a compressing unit that compresses the first image according to an irreversible compression system and compresses the second image according to a reversible compression system;
a storage control unit that causes a predetermined storage area to store information compressed by the compressing unit;
a compressed-information acquiring unit that acquires the compressed information stored in the predetermined storage area;
an expanding unit that expands the information acquired by the compressed-information acquiring unit; and
a combining unit that combines the first image and the second image expanded by the expanding unit, the combining unit adopting image information of the second image to combine the first image and the second image in overlapping sections caused by an extension area of at least one of the first image and the second image.

2. The apparatus according to claim 1, wherein
the objects are objects having any one of plural attributes including an image, a text, and graphics, and
the first image area is an area having the image attribute and the second image area is an area having the attributes other than the image among the plural attributes.

3. The apparatus according to claim 1, further comprising an extended-identification-information generating unit that generates, on the basis of the identification information extracted by the identification-information extracting unit, extended identification information as identification information corresponding to an image area given with the extension area by the divided-image generating unit such that the extended identification information is the same as identification information corresponding to an image area given with the extension area, wherein
the divided-image generating unit generates an image given with the extension area by dividing, on the basis of the extended identification information, an area including the image area given with the extension area and the extension area from the bitmap image.

4. The apparatus according to claim 3, wherein the divided-image generating unit generates an image not given with the extension area by dividing, on the basis of the identification information, an image area corresponding to an image not given with the extension area from the bitmap image.

5. The apparatus according to claim 3, wherein
the compressing unit further compresses the extended identification information, and
the combining unit combines the first image and the second image on the basis of the extended identification information expanded by the expanding unit.

6. The apparatus according to claim 3, wherein the extended-identification-information generating unit generates the extended identification information by generating identification information corresponding to the extension area on the basis of a shape of a contour of an image area given with the extension area in the identification information.

7. The apparatus according to claim 3, wherein
the identification information is information in which the types of the objects are identified for each of the pixels of the bitmap image, and
the extended-identification-information generating unit generates the extended identification information by generating identification information corresponding to the extension area on the basis of a relation in the types of the objects between each of pixels forming an image area given with the extension area in the identification information and pixels adjacent to the each of pixels.

8. The apparatus according to claim 3, further comprising an image complementing unit, wherein
the image complementing unit sets an area, which is excluded when a target area of irreversible compression is divided from the bitmap image in an area divided from the bitmap image as a target area to be compressed according to the irreversible compression system, to a color value same as that of pixels located near a boundary between the excluded area of the target area of irreversible compression and the target area of irreversible compression.

9. The apparatus according to claim 1, wherein the divided-image generating unit gives the extension area by setting the area, which is excluded when the image area is divided from the bitmap image and adjacent to the image area in an image area given with the extension area, to a color value same as that of pixels located near the boundary in the image area.

10. The apparatus according to claim 9, wherein the divided-image generating unit gives the extension area such that a color value of pixels of the extension area is line-symmetrical to, with the boundary set as a symmetry axis, a color value of pixels near the boundary in the image area given with the extension area.

11. The apparatus according to claim 9, wherein the divided-image generating unit gives the extension area to only the first image area and determines, on the basis of length in an up to down direction and length in a left to right direction of the area excluded when the first image area is divided from the bitmap image in the first image area, pixels in the first image area to be set to the same color value in the extension area and a direction of extension by the color value and gives the extension area.

12. An image processing method comprising:
acquiring page information concerning a page, for which image formation is performed, described in page description language;
extracting a bitmap image on the basis of the acquired page information;
extracting, on the basis of the page information, identification information for identifying types of objects included in the page information and identifying to which objects respective pixels of the bitmap image correspond;
generating, on the basis of the identification information, a first image including a first image area in the page and a second image including a second image area different from the first image area such that at least one of the images is an image given with an extension area crossing a boundary between an image area corresponding to the image and the other image area;
compressing the first image according to an irreversible compression system and compressing the second image according to a reversible compression system;
causing a predetermined storage area to store the compressed information;
acquiring the compressed information stored in the predetermined storage area;
expanding the acquired information; and
combining the expanded first image and the expanded second image by adopting image information of the second image in overlapping sections caused by an extension area of at least one of the first image and the second image.

13. The method according to claim 12, wherein
the objects are objects having any one of plural attributes including an image, a text, and graphics, and
the first image area is an area having the image attribute and the second image area is an area having the attributes other than the image among the plural attributes.

14. The method according to claim 12, further comprising:
generating, on the basis of the extracted identification information, extended identification information as identification information corresponding to an image area given with the extension area such that the extended identification information is the same as identification information corresponding to an image area given with the extension area; and
generating an image having the extension area by dividing, on the basis of the extended identification information, an area including the image area given with the extension area and the extension area from the bitmap image.

15. The method according to claim 14, further comprising generating an image not having the extension area by dividing, on the basis of the identification information, an image area corresponding to an image not given with the extension area from the bitmap image.

16. The method according to claim 14, further comprising:
compressing the extended identification information; and
combining the first image and the second image on the basis of the expanded extended identification information.

17. The method according to claim 14, further comprising generating the extended identification information by generating identification information corresponding to the extension area on the basis of a shape of a contour of an image area given with the extension area in the identification information.

18. The method according to claim 14, wherein
the identification information is information in which the types of the objects are identified for each of the pixels of the bitmap image, and
the method further comprising generating the extended identification information by generating identification information corresponding to the extension area on the basis of a relation in the types of the objects between each of pixels forming an image area given with the extension area in the identification information and pixels adjacent to the each of pixels.

19. The method according to claim 14, further comprising setting an area, which is excluded when a target area of irreversible compression is divided from the bitmap image in an area divided from the bitmap image as a target area to be compressed according to the irreversible compression system, to a color value same as that of pixels located near a boundary between the excluded area of the target area of irreversible compression and the target area of irreversible compression.

20. The method according to claim 12, further comprising giving the extension area by setting the area, which is excluded when the image area is divided from the bitmap image and adjacent to the image area in an image area given with the extension area, to a color value same as that of pixels located near the boundary in the image area.

21. The method according to claim 20, further comprising giving the extension area such that a color value of pixels of the extension area is line-symmetrical to, with the boundary set as a symmetry axis, a color value of pixels near the boundary in the image area given with the extension area.

22. The method according to claim 20, further comprising:
giving the extension area to only the first image area; and
determining, on the basis of length in an up to down direction and length in a left to right direction of the area excluded when the first image area is divided from the bitmap image in the first image area, pixels in the first image area to be set to the same color value in the extension area and a direction of extension by the color value and giving the extension area.
